(19) United States
(12) Patent Application Publication
(10) Pub. No.: US 2009/0117247 A1
(43) Pub. Date: May 7, 2009

(54) Starch-Lipid Composite

(75) Inventors: Frederick C. Felker, Morton, IL (US); George F. Fanta, Morton, IL (US); Robert L. Kalebic, New Berlin, WI (US); Wendell E. Turner, Highland Heights, OH (US)

Correspondence Address: RANKIN, HILL & CLARK LLP, 925 EUCLID AVENUE, SUITE 700, CLEVELAND, OH, 44115-1405, US

(73) Assignees: UNITED STATES DEPARTMENT OF AGRICULTURE, Peoria, IL (US); HERITAGE FARE, LTD., Cleveland, OH (US)

(21) Appl. No.: 12/266,658

(22) Filed: Nov. 7, 2008

Related U.S. Application Data
(60) Provisional application No. 60/986,018, filed on Nov. 7, 2007.

(51) Int. Cl. A23L 1/0522

(52) U.S. Cl. 426/578

(57) ABSTRACT

A starch-lipid composite and related composition are described that enhance yield and sensory properties of low fat ground meat. Techniques are described herein for improving the taste and characteristics of ground meat and foods using such, by incorporation of the composite and/or the noted composition.

### STATEMENT REGARDING FEDERAL FUNDING

The present invention was developed, at least in part, in association with the United States Department of Agriculture.

### FIELD OF THE INVENTION

The present invention relates to food additives such as for example, fat substitutes or fat replacers, texture modifiers, flavor carriers, and yield extenders.

### BACKGROUND OF THE INVENTION

The use of starch-lipid composites in low-fat foods, including ground meat, is described in U.S. Pat. Nos. 5,676,994 to Eskins, et al. and 5,882,713 to Eskins, et al. and prior publications, Warner et al. (2001) Food Technology 55:36-41; and, Garzon et al. (2003) Journal of Food Science 68:2050-2056), all of which are hereby incorporated by reference in their entirety. However, those references are general in nature and merely refer to different forms of starch-lipid composites. None of the noted art describes the specific formulations as developed and described herein.

According to the collective experience and knowledge of the inventors, currently known fat replacers and texture enhancers fall short of acceptable levels of quality. And, there are no well distributed products that provide comparable benefits, taste characteristics, and overall quality as the subject formulations.

### SUMMARY OF THE INVENTION

The difficulties and drawbacks associated with previously known food additives are overcome in the present formulations and related methods described herein.

A primary object of the present invention is to enhance the yield and sensory properties of ground meat products by improving yield, flavor, texture, juiciness, and overall quality of cooked ground meat products as compared to higher fat products which typically are greasier and have a fatty flavor. Another primary object of the invention is to enhance the noted properties of ground meat products by improving the noted characteristics as compared to lean ground meat products which are typically drier, chewier, and have less flavor. Such improvements of the sensory properties of a lower fat product will confer significant dietary advantages in terms of reduced fat and reduced calorie content of a very popular food type, i.e. ground meats. In contrast to currently known starch-based meat additives, the subject invention does not persist as a gel in the cooked meat product, but rather blends in with the meat juices upon cooking.

As will be realized, the invention is capable of other and different embodiments and its various details are capable of modifications in various respects, all without departing from the invention. Accordingly, the present description is to be regarded as illustrative and not restrictive.

### DETAILED DESCRIPTION OF THE EMBODIMENTS

A preferred embodiment formulation in accordance with the present invention can be manufactured at any scale with appropriate sizing of a jet cooker, mixing equipment, and fluid handling systems. The following exemplary listing describes the ingredients of a 3500 g batch preferred embodiment precursor composition:

| Ingredients | Amount (grams) |
|---|---|
| distilled water | 2100 |
| glycerol monostearate | 0.6 |
| potato maltodextrin (Paselli SA-2) | 245 |
| high amylose cornstarch (Amylogel 3003, Cerestar) | 585 |
| *fat or oil (tallow, lard, canola oil, etc.) | 298 |
| *salt (NaCl) | 45 |
| *potassium sorbate | 3.6 |
| *sodium benzoate | 3.6 |
| *Grillin WS-50 beef flavor | 9 |
| *natural fatty beef flavor (solid) | 9 |
| modified cornstarch (Firmtex) | 69 |

Notes
*choices of fat type, flavorings, and preservatives are optional and will not significantly influence properties of the preferred embodiment formulations.

It is to be appreciated that the above identified formulation is an exemplary preferred formulation, and that the present invention includes a range of precursor formulations as follows (the noted values are parts by weight):

| | Typical | More Preferred | Most Preferred |
|---|---|---|---|
| Ingredient | Range | Range | Range |
| distilled water | 1,000-3,000 | 1,800-2,400 | 2,100 |
| glycerol monostearate | 0.1-2.5 | 0.3-0.9 | 0.6 |
| Maltodextrin | 50-500 | 200-290 | 245 |
| high amylose cornstarch | 200-1,000 | 500-650 | 585 |
| fat or oil | 50-800 | 200-400 | 298 |
| modified cornstarch | 20-200 | 55-80 | 69 |

Examples of preferred equipment for preparing the present invention formulations are as follows. An excess steam jet cooker, consisting of a hydroheater (HydroThermal Corp., Waukesha, Wis.) supplied with steam at 65-70 psi, a positive displacement pump for introducing the starch slurry, appropriate pressure and temperature gauges, a back pressure valve, and a flash tube for separating excess steam from the cooked product. In addition, a blender such as a Waring blender, stainless steel, one-gallon capacity, preferably controlled with a rheostat is used.

An example of a preferred procedure for preparing a 3500 g batch under laboratory conditions, of a preferred embodiment formulation is as follows. 1000 ml distilled water is heated to about 90° C. in a microwave oven. When transferred to a gallon-size stainless steel Waring blender, the water is hot enough to be above the melting point of glycerol monostearate (GMS). 0.6 g glycerol monostearate (a dry solid) is blended into the water. The GMS melts and forms a milky suspension. Then 1100 ml of water at 25° C. is added while operating the blender to give a dispersion of GMS in water at about 50° C., which is below the gelatinization temperature of cornstarch. 245 g of a potato maltodextrin is added to the water while blending. When it is smoothly dispersed, 585 g high amylose cornstarch is added to form a slurry.

The slurry is jet-cooked under excess steam conditions as follows. A hydroheater is supplied with steam at 65 psi, and the slurry is pumped through the cooker at about 1 liter per minute. The back pressure of the system is adjusted to 40 psi to give a temperature in the hydroheater of approximately 140° C. The cooked product is collected in a preheated stainless steel blender to prevent gelling of the sample.

The fat or oil is then blended into the hot, jet-cooked dispersion under high shear conditions. Then the salt, flavorings, and preservatives are added. After all ingredients are well dispersed, the Firmtex (a viscosity adjusting agent) is added last, which increases the viscosity. The product is kept hot (above 85° C.) to avoid gelling until transferred to any appropriate storage container. The product will form a gel upon cooling to room temperature. The product is then refrigerated before use.

The cold gel is chopped in a Kitchen-Aid food grinder with a ⅛ inch round hole front plate. The gel should break up into small pieces and can be readily incorporated into ground meat products with gentle mixing.

The formula, in particular the ratio of water to the various polysaccharide components, is preferably adjusted to provide the following characteristics of the resulting formulation.

1. The product remains a liquid during production with a viscosity low enough to permit efficient blending of ingredients if held above a certain temperature (about 85° C.).

2. The product forms a firm gel on cooling, and when held under standard refrigeration temperatures (1 to 3° C.) can be handled in a manner similar to beef or pork fat.

3. The product blends into ground meat such that small pieces can be seen in the blended meat product.

4. Upon cooking the meat, the gel softens and blends into the meat juices and is not visible as a white gel in the cooked meat product.

The characteristics of meat products supplemented with the preferred embodiment formulations include:

1. Increased moisture, tenderness, and cooking yield.

2. Enhanced flavor and mouthfeel.

3. Significantly lower fat content when made with leaner ground meat.

The potential commercial value of the present invention formulations and their use in the United States is substantial. As consumers increase their awareness of the negative effects of consuming fatty ground beef (eg 73/27, 80/20), they seek leaner grades (90/10, 95/05). Unfortunately, leaner products do not have the juiciness, taste and mouthfeel of their fuller fat counterparts. This leads to consumer dissatisfaction and militates against the consumers' desire to eat healthier thereby furthering the national health problem. The US consumes 8.4 billion pounds of ground beef annually. Nutrigras, a commercially available fat substitute, is optimally used at a 15% replacement rate. And so, it is reasonable to assume such a replacement rate for the present invention formulations. Therefore, assuming (conservatively) that the use of the present invention formulations do not create any incremental consumption, the commercial potential in the US is about 1.26 billion pounds annually.

Numerous advantages of the preferred embodiment formulations differentiate them from other powder or gel-based fat replacers. These advantages are as follows.

Oil-based flavors can be distributed in the final product with oil droplet sizes in the 1-10 μm range. Many such flavors are preferable to water-based flavors, and there may be a significant improvement in the temporal profile of flavor perception by encapsulating the flavors in the form of lipid droplets. For example, a more persistent aftertaste would be experienced than with water-based flavors, which are rinsed from the mouth more readily while eating. Moreover, volatile, lipid soluble flavors diffuse into the nasal airspace more readily than water-borne flavors.

Both the texture and flavor profile of the gel can be customized for a particular application or customer by adding any combination of flavors, colors, lipid type or content, and by modifying the water content or levels of specific ingredients to shift the gel properties in various directions as needed. For example, the rigidity or softness of the gel can be changed with slight modifications in the amounts of different ingredients.

Starch-lipid composites are made without chemical emulsifiers, which simplifies the production and interferes less with the physics of the other food components. Also, the package labeling is made simpler and more acceptable by consumers by eliminating the need to include the names of chemical emulsifiers.

The product is designed to be incorporated into the ground meat in the same physical form and at the same point in the processing stream as fat. Therefore it requires no special modifications of processing techniques by meatpackers, as opposed to other products which may require addition of powders, etc.

The product can be conveniently packaged in a variety of container types and sizes, and is handled in existing cold storage facilities along with the meat itself.

The formulation is produced with readily available equipment (steam jet cooker, pumps, mixers, etc.) and requires no specialized or custom-fabricated apparatus.

The formula is designed to be produced as a viscous, pumpable liquid which sets up to a gel after containers are filled, which facilitates packaging and handling.

The process is a physical processing technique and involves no chemical reactions or further modification of ingredients.

The preferred embodiment formulations have been identified as described herein. However, the complexity of the formula precludes testing the vast permutations and combinations that would be needed to establish broad limits of each ingredients. Moreover, some of the ingredients are linked by interaction, such that an increase in one would require a decrease in another, etc.

What is claimed is:

1. A precursor composition for forming a food additive, the precursor composition comprising:
water;
glycerol monostearate;
maltodextrin;
high amylase cornstarch; and
modified cornstarch

2. The precursor composition of claim 1 wherein the composition comprises:
from about 1,000 to about 3,000 parts by weight water;
from about 0.1 to about 2.5 parts by weight glycerol monostearate;
from about 50 to about 500 parts by weight maltodextrin;
from about 200 to about 1,000 parts by weight high amylase cornstarch;
from about 50 to about 800 parts by weight fat or oil; and
from about 20 to about 200 parts by weight modified cornstarch.

3. The precursor composition of claim 1 wherein the composition comprises:
from about 1,800 to about 2,400 parts by weight water;
from about 0.3 to about 0.9 parts by weight glycerol monostearate;
from about 200 to about 290 parts by weight maltodextrin;
from about 500 to about 650 parts by weight high amylase cornstarch;
from about 200 to about 400 parts by weight fat or oil; and
from about 55 to about 80 parts by weight modified cornstarch.

4. The precursor composition of claim 1 wherein the composition comprises:
about 2,100 parts by weight water;
about 0.6 parts by weight glycerol monostearate;
about 245 parts by weight maltodextrin;
about 585 parts by weight high amylase cornstarch;
about 298 parts by weight fat or oil; and
about 69 parts by weight modified cornstarch.

5. A method of preparing a food additive, the method comprising:
heating a first portion of water to a temperature greater than the melting point of glycerol monostearate;
adding an effective amount of glycerol monostearate to the heated water, to form a suspension;
blending a second portion of water at ambient temperature to the suspension to form a dispersion which is at a temperature less than the gelatinization temperature of cornstarch;
adding an effective amount of maltodextrin to the dispersion;
adding an effective amount of high amylase cornstarch to the dispersion after adding the maltodextrin to thereby form a slurry;
heating the slurry under excess steam conditions to produce a cooked product;
blending a desired amount of fat or oil with the cooked product under high shear conditions to form the food additive; and
cooling the food additive to induce gelling of the additive.

6. The method of claim 5 wherein prior to cooling the food additive, a viscosity adjusting agent is added.

7. The method of claim 5 wherein after blending fat or oil, a desired amount of salt, flavorings, preservatives, or combinations thereof are added.

8. The product produced by the method of claim 5.

9. A method of improving the taste and/or mouthfeel of ground meat by adding an effective amount of the product of claim 8 to ground meat.
